(19) United States
(12) Patent Application Publication
(10) Pub. No.: US 2024/0134560 A1
(43) Pub. Date: Apr. 25, 2024

(54) MANAGING ABORT TASKS IN METRO STORAGE CLUSTER

(71) Applicant: Dell Products L.P., Round Rock, TX (US)

(72) Inventors: Dmitry Nikolayevich Tylik, Westborough, MA (US); Yan Xu, Boston, MA (US); Stanislav Gorshkov, Saint Petersburg (RU)

(21) Appl. No.: 17/972,984

(22) Filed: Oct. 24, 2022

(51) Int. Cl. G06F 3/06; G06F 9/52

(52) U.S. Cl. CPC G06F 3/0653; G06F 3/0607; G06F 3/0665; G06F 3/0688; G06F 9/52

(57) ABSTRACT

A technique is disclosed for managing abort tasks in a metro cluster that includes a first array and a second array. The technique includes receiving, by the first array, a write request from a host, the write request specifying a range of data to be written to a stretched volume. The technique further includes receiving an abort task from the host for aborting the write request. In response to receipt of the abort task, the technique further includes the first array delaying a successful response to the abort task back to the host until the first array receives a notification that the second array has locked the range of data specified by the write request.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

Some data storage systems, also called “arrays,” arrange their data in metro clusters. “Metro clusters” are storage deployments in which two volumes hosted from respective arrays at respective sites are synchronized and made to appear as a single volume to application hosts. Such volumes are sometimes called metro or “stretched” volumes because they appear to be stretched between two arrays. Primary advantages of metro clusters include increased data availability, disaster avoidance, resource balancing across datacenters, and storage migration.

Sometimes, a host may attempt to issue an abort task on a write request that it previously issued to a stretched volume. Abort tasks are well-known SCSI (small computer systems interface) instructions. Storage systems are typically designed to respond quickly to abort tasks, such as by promptly reporting success of an abort task back to an initiating host and reporting failure of the subject write request. The write request itself might or might not complete, depending on where it is in its processing when the abort task is received. No assumption is made as to the state of the data of a failed write.

### SUMMARY

Unfortunately, inconsistencies can arise when processing abort tasks in a metro cluster. For example, if a host issues a write request to an address of a stretched volume on a first storage system and then issues an abort task, the first storage system may report success of the abort task to the initiating host and may further report that the write request has failed. Meanwhile, a second storage system of the metro cluster may receive a host read request for the same address on the stretched volume after the first storage system has issued the abort success but before the second storage system has received the replicated write. The write request may eventually reach the second storage system, and if the write at the second storage system completes, then a second read request to the same address on the second storage system may provide a different result than it provided in response to the first read request. This behavior violates SCSI standards, as two different results are obtained for the same address on the same stretched volume without there being an intervening host write. What is needed is a way of managing abort tasks in a metro cluster so as to maintain consistency and avoid violating SCSI standards.

The above need is addressed at least in part by an improved technique for managing abort tasks in a metro cluster that includes a first array and a second array. The technique includes receiving, by the first array, a write request from a host, the write request specifying a range of data to be written to a stretched volume. The technique further includes receiving an abort task from the host for aborting the write request. In response to receipt of the abort task, the technique further includes the first array delaying a successful response to the abort task back to the host until the first array receives a notification that the second array has locked the range of data specified by the write request.

Advantageously, the improved technique avoids violating SCSI standards. Rather, the data in the specified range is locked at least as of the time of issuance of the abort response, and no reading or writing of the data is permitted until the lock is released. While the lock is being held, the first and second arrays can coordinate to achieve a consistent state of the data in the specified range, either by leaving the old data in place or by updating the range with new data as specified by the aborted write request. Consistency is therefore maintained and SCSI standards are obeyed.

Certain embodiments are directed to a method of managing abort tasks in a metro cluster that includes a first array and a second array. The method includes receiving, by the first array, a write request from a host, the write request specifying data to be written to a specified range of a stretched volume of the metro cluster. After receiving the write request, the method further includes receiving an abort task from the host for aborting the write request. In response to receipt of the abort task, the method still further includes delaying, by the first array, a successful response to the abort task back to the host until after the first array receives a notification that the second array has acquired a lock on the specified range in the second array.

Other embodiments are directed to a computerized apparatus constructed and arranged to perform a method of managing abort tasks in a metro cluster, such as the method described above. Still other embodiments are directed to a computer program product. The computer program product stores instructions which, when executed on control circuitry of a computerized apparatus, cause the computerized apparatus to perform a method of managing abort tasks in a metro cluster, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views.

FIG. 1 is a block diagram of an example metro-cluster environment in which embodiments of the improved technique can be practiced.

FIG. 2 is a block diagram of an example array of the metro-cluster environment of FIG. 1.

FIG. 3 is a flowchart showing an example method of responding to an abort task received by a preferred array in the metro-cluster environment of FIG. 1.

FIG. 4 is a flowchart showing a first example method of responding to an abort task received by a non-preferred array in the metro-cluster environment of FIG. 1.

FIG. 5 is a flowchart showing a second example method of responding to an abort task received by a non-preferred array in the metro-cluster environment of FIG. 1.

FIG. 6 is a flowchart showing an example method of managing abort tasks in a metro cluster.

### DETAILED DESCRIPTION

Embodiments of the improved technique will now be described. One should appreciate that such embodiments are provided by way of example to illustrate certain features and principles but are not intended to be limiting.

An improved technique is disclosed for managing abort tasks in a metro cluster that includes a first array and a second array. The technique includes receiving, by the first array, a write request from a host, the write request specifying a range of data to be written to a stretched volume. The technique further includes receiving an abort task from the host for aborting the write request. In response to receipt of the abort task, the technique further includes the first array delaying a successful response to the abort task back to the host until the first array receives a notification that the second array has locked the range of data specified by the write request.

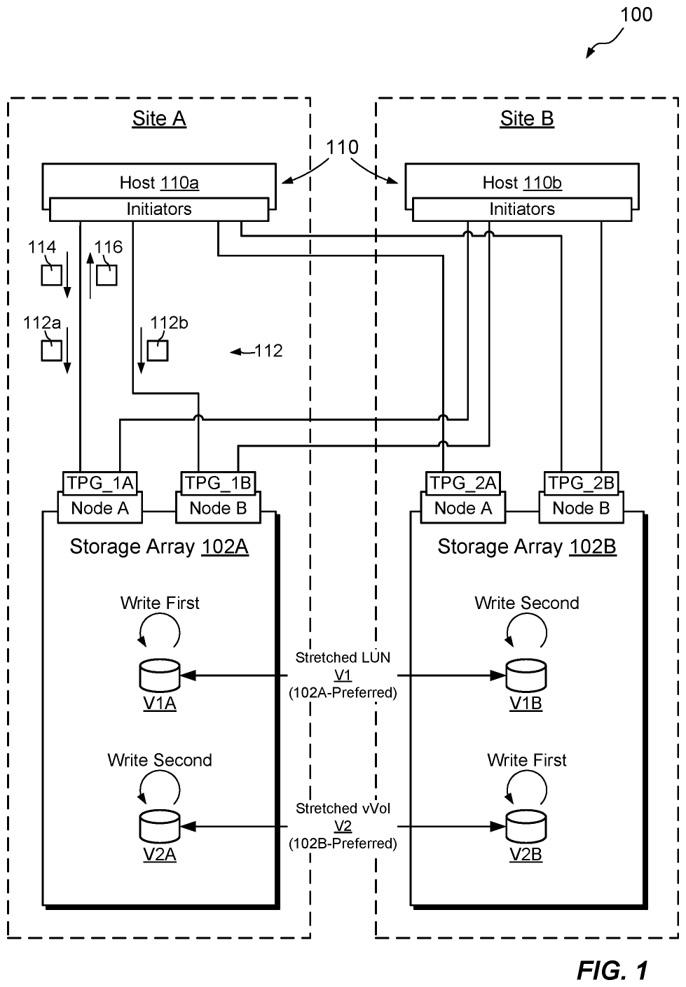

FIG. 1 shows an example metro-cluster environment 100 in which embodiments of the improved technique can be practiced. Here, a first Array 102A operates at Site A and a second Array 102B operates at Site B. Each array 102 may include one or more storage computing nodes (e.g., Node A and Node B) as well as persistent storage, such as magnetic disk drives, solid state drives, and/or other types of storage drives. Site A and Site B may be located in different data centers, different rooms within a data center, different locations within a single room, different buildings, or the like. Site A and Site B may be geographically separate but are not required to be. Generally, to meet customary metro cluster requirements, Site A and Site B may be separated by no more than 100 km.

Environment 100 further includes hosts 110 (e.g., Host 110a and Host 110b). Hosts 110 run applications that store their data on Array 102A and/or Array 102B. The hosts 110 may connect to arrays 102 via a network (not shown), such as a storage area network (SAN), a local area network (LAN), a wide area network (WAN), the Internet, and/or some other type of network or combination of networks, for example.

Each array 102 is capable of hosting multiple data objects, such as host-accessible LUNs (Logical UNits), file systems, and virtual machine disks, for example, which the array may store internally in the form of “volumes.” Internal volumes may also be referred to as LUNs, i.e., the terms “volume” and “LUN” may be used interchangeably herein when referring to internal representations of data objects. Some hosted data objects may be stretched, meaning that they are deployed in a metro-cluster arrangement in which they are accessible from both Arrays 102A and 102B, e.g., in an Active/Active manner, with their contents being maintained in synchronization. For example, volume V1 may represent a stretched LUN and volume V2 may represent a stretched vVol. Environment 100 may present each stretched data object to hosts 110 as a single virtual object, even though the virtual object is maintained internally as a pair of objects, with one object of each pair residing on each array. In the example shown, stretched volume V1 (a LUN) resolves to a first volume VIA in Array 102B and a second volume V1B in Array 102B. Likewise, stretched volume V2 (a vVol) resolves to a first volume V2A in Array 102A and a second volume V2B in Array 102B. One should appreciate that each of the arrays 102A and 102B may host additional data objects (not shown) which are not deployed in a metro-cluster arrangement and are thus local to each array. Thus, metro clustering may apply to some data objects in the environment 100 but not necessarily to all.

As further shown, each array 102 may be assigned as a “preferred array” or a “non preferred array.” Preference assignments are made by arrays 102 and may be automatic or based on input from an administrator, for example. In some examples, array preferences are established on a per-data-object basis. Thus, for stretched LUN (V1), Array 102A may be assigned as the preferred array and Array 102B may be assigned as the non-preferred array. The reverse may be the case for stretched vVol (V2), where Array 102B may be assigned as preferred and Array 102A as non-preferred.

Assignment of an array as preferred or non-preferred may determine how synchronization is carried out across the two arrays. As a particular example, which is not intended to be limiting, when a write request to a data object is received (e.g., from one of the hosts 110), the preferred array for that data object is always the first array to persist the data specified by the write request, with the non-preferred array being the second array to persist the data. This is the case regardless of whether the preferred array or the non-preferred array is the one that receives the write request from the host. Thus, a first write request received by the preferred array is written first to the preferred array, but also a second write request received by the non-preferred array is written first to the preferred array.

As a particular example, assume that Host 110a issues an I/O request 112a specifying a write of host data to the stretched LUN (V1), with Array 102A being the target. Array 102A receives the write request 112a and checks whether it is the preferred or non-preferred for the referenced data object, stretched LUN V1. In this example, Array 102A is preferred, so Array 102A persists the data first (“Write First”), by writing to V1A. Only after such data are persisted on Array 102A does Array 102A replicate the write request 112a to Array 102B, which then proceeds to “Write Second” to V1B.

But assume now that Host 110a issues an I/O request 112b specifying a write of host data to the stretched vVol (V2), again with Array 102A being the target. Array 102A receives the write request and checks whether it is preferred or non-preferred for the stretched vVol. In this case, Array 102A is non-preferred, so Array 102A forwards the write request 112b to Array 102B (preferred), which proceeds to “Write First” to V2B. Only after Array 102B has persisted this data does Array 102B send control back to Array 102A, which then proceeds to “Write Second” to V2A.

Although both examples above involve Array 102A being the target of the write requests 112a and 112b, similar results follow if Array 102B is the target. For example, if request 112a arrives at Array 102B, Array 102B determines that it is non-preferred for V1 and forwards the request 112a to Array 102A, which would then write first to V1A. Only then does request 112a return back to Array 102B, which writes second to V1B. As for write request 112b, Array 102B determines that it is preferred and writes first to V2B, and then forwards the request 112b to Array 102B, which then writes second to V2A.

The disclosed technique of writing first to the preferred array brings many benefits. As the array preference for any data object is known in advance, it is assured that the preferred array always stores the most up-to-date data. If a link between the arrays fails or the data on the two arrays get out of sync for any reason, it is known that the most recent data can be found on the preferred array. Additional information about metro clusters employing a write-first protocol for preferred arrays may be found in copending U.S. publication number US/20220236877, filed Jan. 22, 2021, the contents and teachings of which are incorporated herein by reference in their entirety.

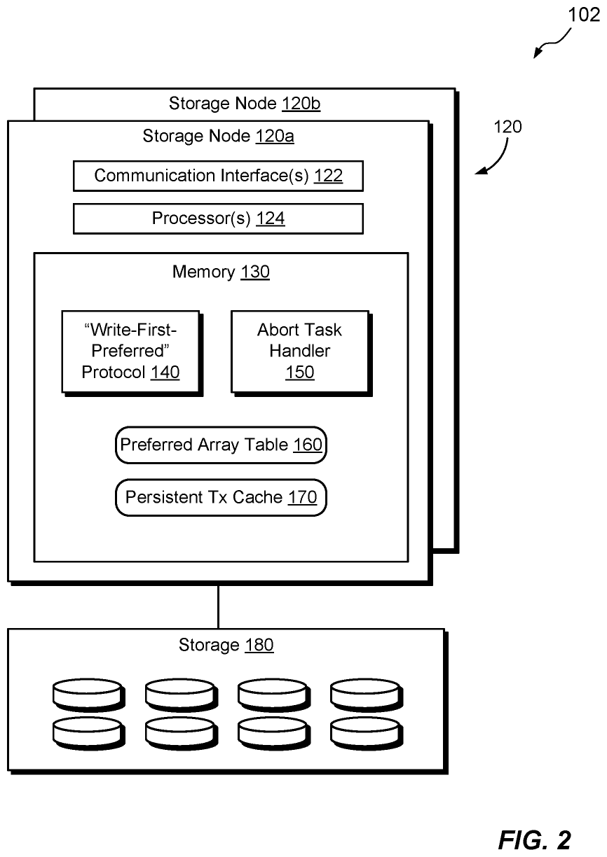

FIG. 2 shows an example arrangement of a storage array 102 of FIG. 1 in greater detail. Array 102 may be representative of Array 102A and Array 102B; however, there is no requirement that the two arrays 102A and 102B be identical.

Array 102 is seen to include a pair of storage nodes 120 (i.e., 120a and 120b; also called storage processors, or “SPs”), as well as storage 180, such as magnetic disk drives, electronic flash drives, and/or the like. Nodes 120 may be provided as circuit board assemblies or blades, which plug into a chassis that encloses and cools the nodes 120. The chassis has a backplane or midplane for interconnecting the nodes, and additional connections may be made among nodes using cables. In some examples, nodes 120 are part of a storage cluster, such as one which contains any number of storage appliances, where each appliance includes a pair of nodes 120 connected to shared storage devices. No particular hardware configuration is required, however.

As shown, node 120a includes one or more communication interfaces 122, a set of processors 124, and memory 130. The communication interfaces 122 include, for example, SCSI target adapters and/or network interface adapters for converting electronic and/or optical signals received over a network to electronic form for use by the node 120a. They may further include, in some examples, NVMe-oF (Nonvolatile Memory Express over Fabrics) ports. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 2, the memory 130 “includes,” i.e., realizes by execution of software instructions, a write-first-preferred protocol 140 and an abort task handler 150. The write-first-preferred protocol 140 is configured to manage tasks associated with writing first to preferred arrays and writing second to non-preferred arrays, and thus helps to avoid deadlocks and maintain synchronization of data objects across the environment 100. The abort task handler 150 is configured to manage the processing of abort tasks in the environment 100. Although the abort task handler 150 is shown as a separate component from the write-first preferred protocol 140, the abort task handler 150 may alternatively be part of the write-first preferred protocol 140, or the two components may be part of some other component or group of components. The example shown is merely illustrative.

As further shown in FIG. 2, the memory 130 includes a preferred array table 160 and persistent transaction (Tx) cache 170. Preferred array table 160 is a data structure that associates data objects hosted by the local array 102a or 102b with corresponding preferred arrays and, in some cases with corresponding non-preferred arrays (e.g., if not implied). Contents of the preferred array table 160 may be established by the node 120a based on input from a system administrator or automatically, e.g., based on any desired criteria, such as load distribution, location of arrays and/or hosts, network topology, and the like. Preferred array table 160 may also be stored in shared memory, or in persistent memory accessible to both nodes 120. Alternatively, it may be stored locally in each node and mirrored to the other. In some examples, preferred array table 160 is replicated across arrays, such that both preferred and non-preferred arrays have the same table of assignments.

Persistent Tx cache 170 is configured to store transactions, e.g., sets of changes in data and/or metadata, which are made atomically. For example, transactions may be formed in memory and then committed to the persistent Tx cache 170 once they are complete. Data specified by write requests 112 from hosts 110 are typically persisted via transactions. For example, host data written to storage node 120a may be received into volatile memory buffers (not shown) and then copied to the persistent Tx cache 170 as part of a transaction. Once the copy is complete and the transaction is committed in the Tx cache 170, the host data is persisted and the write request 112 may be acknowledged as successful. Tx Cache 170 is preferably implemented in high-speed non-volatile memory, such as flash storage, which may include NVMe-based flash storage, for example.

Aspects of abort-task management will now be described with reference briefly to FIG. 1. Abort tasks are SCSI commands for terminating tasks, such as write requests and other tasks. An abort task may identify a particular write request (e.g., by a task tag field), or it may apply to all tasks (an “abort task set”) issued by a particular SCSI initiator on a particular logical unit.

Normally, an abort task is issued by the same host (initiator) that issued the write request or requests being aborted. Thus, for example, host 110a may issue a write request 112 to Node A on storage array 102A, directed to a range of data on a stretched volume, such as stretched LUN (V1) or stretched vVol (V2), and then may later issue an abort task 114 to abort the write request 112. As both the write request 112 and the abort task 114 are received by a single array 102A in the metro-cluster environment 100, a possibility exists that inconsistencies and SCSI violations can occur in the stretched volume, which is between both arrays 102A and 102B. As described in the examples that follow, such inconsistencies and violations can be avoided at least in part by ensuring that the array that receives the abort task 114 waits to acknowledge the abort task as successful (response 116) until it receives confirmation that the range of data specified by the write request being canceled has been locked on the other array.

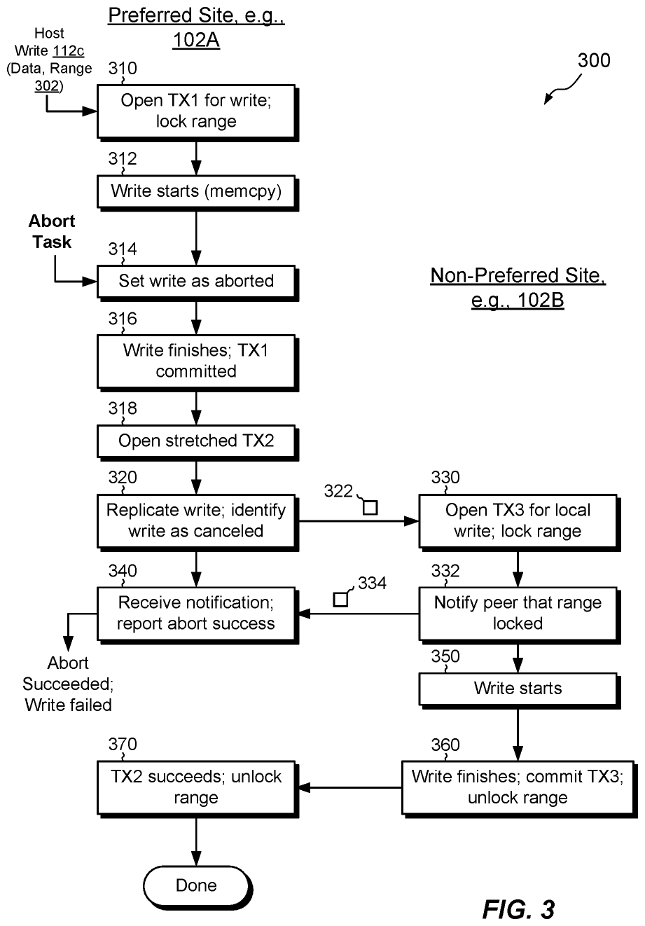

FIGS. 3-6 show example methods 300, 400, 500, and 600 that may be carried out in connection with the environment 100. The methods 300, 400, 500, and 600 are typically performed, for example, by the software constructs described in connection with FIG. 2, which reside in the memory 130 of a node 120 of an array 102, or on a respective node 120 of each of arrays 102A and 102B, and are run by the set or the respective set of processors 124. The various acts of methods 300, 400, 500, and 600 may be ordered in any suitable way. Accordingly, embodiments may be constructed in which acts are performed in orders different from those illustrated, which may include performing some acts simultaneously.

FIG. 3 shows a first example method 300 for handling an abort task 114 for a write request 112c directed to a stretched data object. For this example, it is assumed that the write request 112c is received by the preferred array, e.g., the array designated as preferred for the stretched data object in the preferred array table 160.

Method 300 begins at 310, whereupon a node 120 of the preferred array (array 102A in this example), receives a write request 112c from a host 110. The write request 112c is directed to a data object, such as a LUN, file system, vVol, or the like, and provides data to be written to a specified range 302 of that data object. The range 302 may be expressed in any suitable manner, which may depend on the type of data object being written. For example, if the data object is a LUN, then the range 302 may be specified by logical unit number, offset, and size. But if the data object is a file system, then the range may be specified by file system identifier (FSID), pathname, and offset range, for example. Within the node 120, the range 302 may be mapped to a corresponding range of blocks within a volume. If we assume that the data object being written is the LUN of FIG. 1, then the volume to which the blocks are mapped may be volume V1A, which is one side of stretched volume V1.

In response to receiving the write request 112c from the host 110, array 102A (e.g., a node 120 on array 102A) proceeds to open a new transaction (TX1) for implementing the requested write. Array 102A also locks the specified range, e.g., the range of mapped blocks within volume VIA that correspond to the range 302 specified by the write request 112c. The lock is preferably exclusive and prevents both reading and writing.

At 312, array 102A begins an internal write operation within the context of TX1. In an example, the write operation is a memory copy (memcpy) in which the array 102A copies the specified data of the write request 112c from volatile memory buffers to nonvolatile cache, such as the persistent Tx cache 170. One should appreciate that the internal write operation cannot normally be interrupted once it has begun.

At 314, after the write operation has begun but before it has finished, Array 102A receives an abort task 114 from the host 110. For example, the host 110 may have issued the abort task 114 because it failed to receive an acknowledgement of the write request 112c within an expected amount of time. Whatever the reason, array 102A internally sets the write request 112c to an aborted state.

At 316, the internal write to Tx cache 170 finishes and the transaction TX1 is committed, meaning that the data specified by the write request 112c is persisted in array 102A. Because volume VIA is part of a stretched volume V1, and because the write has completed on array 102A, the write must be replicated to array 102B to maintain consistency across both sides of the stretched volume V1.

Thus, at 318 array 102A opens a stretched transaction TX2 for replicating the write to array 102B, which in this example is non-preferred.

At 320, array 102A replicates the write to array 102B. At or about this time, array 102A also sends a message 322 notifying array 102B that the write has been canceled.

At 330, the non-preferred array 102B (e.g., a node 120 of array 102B) opens a new transaction (TX3) for performing the write locally. The array 102B locks the range 302 on its version of the stretched volume, in this case volume V1B. The lock is preferably exclusive and prevents both reading and writing.

At 332, array 102B notifies array 102A that the range 302 has been locked. A notification 334 issued at 332 may be solicited by array 102A or it may be unsolicited. The details of the notification are not critical.

At 340, back on the preferred array 102A, the notification 334 is received that the range 302 has been locked on array 102B. At this point, it is safe for array 102A to provide a response 116 to the host 110 that the abort task 114 was successful. Array 102A may do so at this time and may also inform the host 110 that the write request 112c has failed.

As the range 302 has been locked on both sides, i.e., on 102A (V1A) and on 102B (V1B), no further reads or writes can occur on this range and there can be no basis for inconsistency. Thus, it is safe to inform the host 110 that the abort task 114 was successful, even though additional activity may still be needed to make both volumes VIA and V1B consistent. Such activity takes place under the locks and therefore is not visible to hosts.

For example, activity may continue at 350, where the non-preferred array 102B starts its own write under transaction TX3, e.g., to its own Tx Cache 170.

At 360, the write to cache completes, and transaction TX3 is committed, meaning that the non-preferred array 102B has persisted the data. The range on V1B can then be unlocked.

At 370, array 102A receives an indication that the write on array 102B is complete. Array 102A then closes the stretched transaction TX2, which has succeeded, and unlocks the corresponding range on VIA. The process is then complete.

Notably, the data specified by the write request 112c has been written to both arrays 102A and 102B, and this has happened despite the abort task 114 having successfully completed. As mentioned previously, though, no assumption shall be made as to the state of a failed write request. Thus, the fact that the write eventually completes does not violate SCSI standards. In addition, completion of the write on both arrays 102A and 102B ensures that the stretched volume V1 is consistent on both sides.

By waiting to respond to the abort task 114 until the non-preferred array 102B has locked the range 302, the preferred array 102A is able to inform the host 110 that the abort task 114 has succeeded as quickly as safely possible. Responding any earlier would leave open the possibility of an intervening read of the specified range on the non-preferred array 102B, while responding later would cause the host 110 to suffer additional delay. Given that the host 110 may already be delayed by a slow response to the write request 112c, waiting any longer than necessary to issue a response 116 would delay the host even more. Thus, the abort response 116 is provided as soon as it is safe even though processing of the original write request has not yet been completed.

A different result may have occurred if the abort task 114 had arrived before the internal write operation began at 312. For example, if the abort task 114 had instead arrived between acts 310 and 312, then there would have been no need to proceed with the internal write. Rather, the write transaction TX1 would merely be canceled. The preferred array 102A would issue a response 116 to the host 110 that the abort task 114 was successful and would fail the write request 112c. No internal write or replication would be performed.

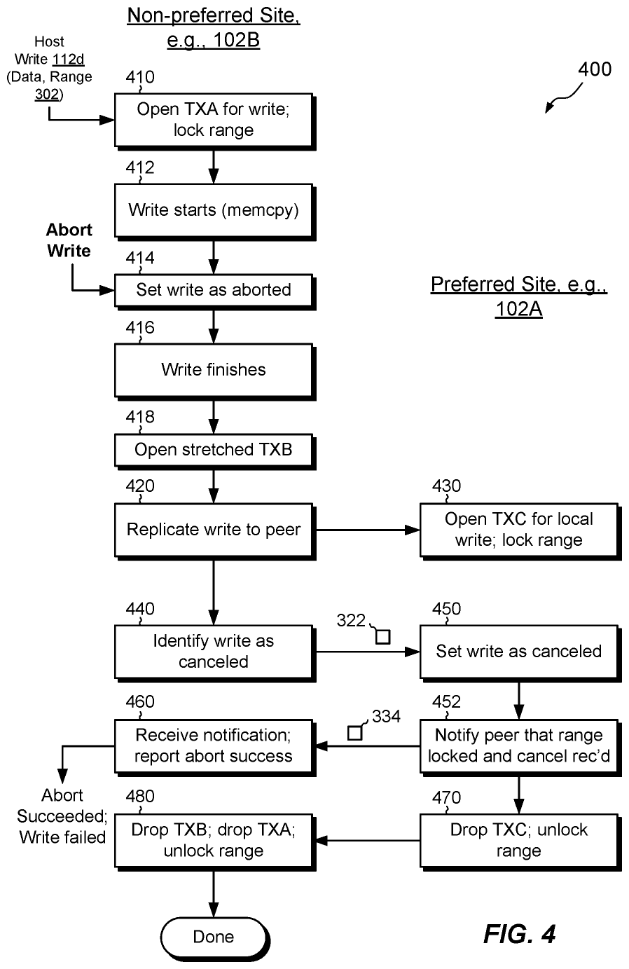

FIG. 4 shows a different example. Here, it is assumed that array 102B (non-preferred) is the array that receives a write request. The method 400 differs from the method 300 above, given the different treatment of writes in preferred versus non-preferred arrays.

At 410, the non-preferred array 102B receives a write request 112d from a host 110, again specifying data to be written to a specified range 113. Array 102B (e.g., a node 120 running on array 102B) then opens a transaction TXA for the local write and locks the range 113 (e.g., for both reading and writing). At 412, array 102B starts an internal write operation, e.g., a memcpy from volatile buffers to TX cache 170 in array 102B.

At 414, array 102B receives an abort task 114 from a host 110, this time specifying an abort of I/O request 112d. Array 102B internally sets the write request 112d to an aborted state.

At 416, the internal write completes. This time, however, transaction TXA is not committed, as was the transaction TX1 in FIG. 3, as array 102B is non-preferred for the stretched volume and thus cannot complete its own write before the write is completed on the preferred array 102A.

At 418, non-preferred array 102B opens a stretched transaction TXB, and at 420 array 102B replicates the write request 112d to the peer, i.e., to the preferred array 102A, within the stretched transaction TXB.

At 430, preferred array 102A receives the replicated write and opens a transaction TXC for performing a local, internal write (e.g., memcpy) of the replicated data to its own Tx cache 170. Array 102A also obtains a lock (e.g., read and write lock) on the specified range 113.

At 440, the non-preferred array 102B recognizes the abort task 114, which may have been held back during the internal copy, and sends a message 322 to the preferred array 102A indicating that the write request 112d has been canceled. At 450, the preferred array 102A responds by internally setting the write 112d to a canceled state. At 452, the preferred array 102A notifies the non-preferred array 102B that the cancellation of the write 112d has been received. At or around this time, the preferred array 102A also notifies the non-preferred array 102B (notification 334) that the preferred array 102A has locked the specified range 113. In this example, the lock was taken during the act 430.

At 460, the non-preferred array 102B receives the notification from the preferred array 102A that the lock has been released. The non-preferred array 102B then issues a response 116 back to the host 110, indicating that the abort task 114 was successful and that the write request 112d has failed.

Once again, the array receiving the abort task 114 holds back the abort-task response 116 until it receives notification 334 that the other array has locked the specified range 113. Sending the abort-task response 116 any earlier would risk intervening reads on the preferred array 102A, and waiting any longer would add to the delay experienced by the requesting host 110.

Back on the preferred array 102A, operation proceeds to 470, whereupon the preferred array 102A cancels the local write transaction TXC and unlocks the range that was locked at 430. Thus, no new write is performed on the preferred array 102A. The preferred array 102A then informs the non-preferred array 102B that the write 112d on array 102A has been canceled.

At 480, the non-preferred array 102B may unwind the write locally, e.g., by canceling the stretched transaction TXB and by further canceling its own local write transaction TXA. Uncommitted data of the write request 112d, which was copied to the TX cache 170, may be erased or otherwise invalidated, and the locked range on array 102B may be unlocked. The method 400 then completes.

At the conclusion of method 400, the range 113 that was specified by the write request 112d contains old data, i.e., the data that was present in that range prior to the write request 112d. This is a reasonable outcome, given that the preferred array 102A had not yet begun writing the data of request 112d to its Tx cache 170 when it received the indication (at 450) that the write had been canceled. As the write request 112d has already failed, it does not matter whether the write 112d is completed, and it is more efficient not to complete it. Also, the contents of volumes VIA and V1B are consistent with each other.

As in the previous example, if the abort task 114 were to arrive before the internal write had begun (in this case, on the non-preferred array 102B), then the write request 112d would simply be cancelled and a successful response 116 to the abort task 114 would be issued. There would be no need to proceed with the write 112d if the internal write had not begun.

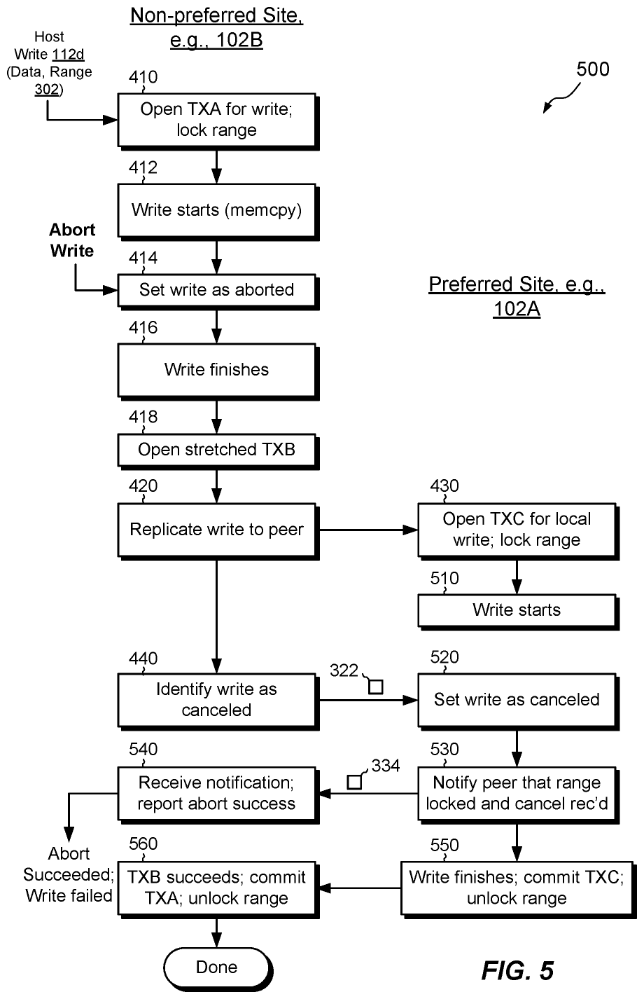

FIG. 5 shows the same example as in FIG. 4, with the main difference being that the preferred array 102A has already begun its internal write of the replicated request when it receives the message that write has been canceled.

Here, acts 410, 412, 414, 416, 418, 420, 430, and 440 are the same as the acts depicted in FIG. 4, but this time, when the non-preferred array 102B sends the message 322 to the preferred array 102A that the write 112d has been canceled, the preferred array 102A has already begun writing the data of the write request 112d to its Tx cache 170 (at 510). As the internal write cannot generally be interrupted, it is allowed to proceed. At 520, the preferred array 102A sets the write 112d to a canceled state, and at 530, the preferred array 102A notifies the non-preferred array 102B that it received the cancelation and that the range 113 specified by the write 112d has been locked (notification 334).

At 540, the non-preferred array 102B receives the notification 334 that the range has been locked and proceeds to send an abort-task response 116 to the host 110, informing the host 110 that the abort task 114 succeeded. It may also send a response indicating that the write request 112d has failed. Once again, reporting success of the abort task 114 any sooner would risk an intervening read, whereas waiting any longer would unnecessarily delay the host 110.

Back on the preferred array 102A, the internal write completes at 550. Local transaction TXC is then committed, and the affected range is unlocked. The preferred array 102A then informs the non-preferred array 102B that the write 112d was successful.

At 560, the non-preferred array 102B proceeds to complete the write 112d locally, e.g., by closing the stretched transaction TXB, which has succeeded, and by committing the local write transaction TXA. The non-preferred array 102B then unlocks the affected range, and the method 500 completes.

At the conclusion of method 500, the specified range 113 contains new data, i.e., the data specified in the write request 112d. Volumes VIA and V1B are thus consistent with each other.

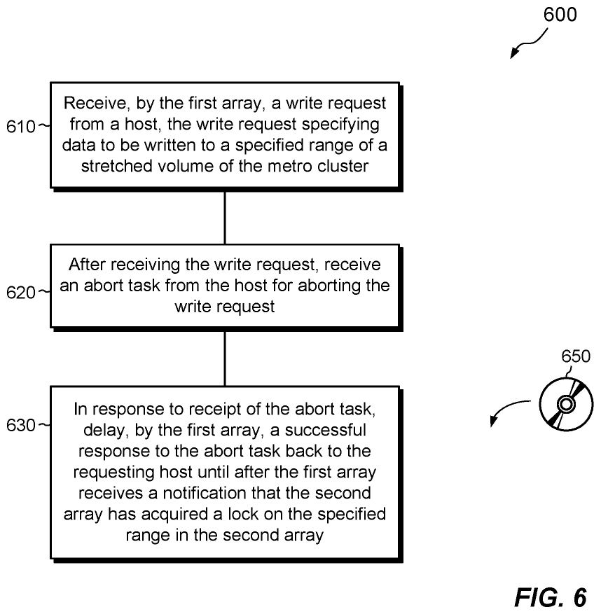

FIG. 6 shows an example method 600 of managing abort tasks 114 in a metro cluster 100 that includes a first array and a second array and provides a summary of some of the features described above. At 610, the first array of the metro cluster 100 receives a write request 112 from a host 110. The write request 112 specifies data to be written to a specified range 113 of a stretched volume (e.g., V1) of the metro cluster 100. The first array may be a preferred array (e.g., 102A in FIG. 3), or it may be a non-preferred array (e.g., 102B in FIGS. 4 and 5).

At 620, after receiving the write request 112, the first array receives an abort task 114 from the host 110 for aborting the write request 112.

At 630, in response to receipt of the abort task 114, the first array delays a successful response 116 to the abort task 114 to the requesting host 110 until after the first array receives a notification 334 that a second array has acquired a lock on the specified range 113 in the second array.

If the first array is a preferred array (e.g., 102A in FIG. 3) and an internal write on the first array has already begun when the abort task 114 is received, then the write request 112 may continue to completion and may be replicated to the non-preferred array 102B, where the write request 112 also continues to completion. But if the first array is a non-preferred array (e.g., 102B in FIGS. 4 and 5), then whether the write request 112 completes or not may depend on whether an internal write on the second (preferred) array 102A has already begun when the second array is informed of the aborted write. If the internal write on the second (preferred) array has already begun, then the write request 112 may continue to completion on both arrays, and the data of the range specified by the write request 112 may be new data, i.e., that specified by the write request 112. But if the internal write on the second array has not begun when it is informed of the aborted write, then the write request 112 may be dropped on both arrays, with the data of the specified range staying as old data, i.e., the data that appeared in the range 113 before receipt of the write request 112.

An improved technique has been described for managing abort tasks 114 in a metro cluster 100 that includes a first array (102A or 102B) and a second array (102B or 102A). The technique includes receiving, by the first array, a write request 112 from a host 110, the write request 112 specifying a range 113 of data to be written to a stretched volume. The technique further includes receiving an abort task 114 from the host 110 for aborting the write request 112. In response to receipt of the abort task 114, the technique further includes the first array delaying a successful response 116 to the abort task 114 back to the host until the first array receives a notification 334 that the second array has locked the range of data specified by the write request 112.

Advantageously, the improved technique avoids any risk of violating the SCSI standard. Rather, the data in the specified range 113 is locked at least as of the time of issuance of the abort response 116, and no reading or writing of the data is permitted until the lock is released. While the lock is being held, the first and second arrays can coordinate to achieve a consistent state of the data in the specified range 113, either by leaving the old data in place or by updating the range with new data as specified by the aborted write request 112. Consistency is thus maintained and SCSI standards are obeyed.

Having described certain embodiments, numerous alternative embodiments or variations can be made. For example, although embodiments have been described in which write requests 112 are completed or not depending on whether a preferred array has begun an internal write of specified data when an abort task 114 is recognized, this is merely an example. Alternatively, a policy could be employed in which write requests 112 are always completed, are never completed, or are completed or not depending on other factors besides whether an internal write has begun.

Also, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 650 in FIG. 6). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of managing abort tasks in a metro cluster that includes a first array and a second array, comprising:
receiving, by the first array, a write request from a host, the write request specifying data to be written to a specified range of a stretched volume of the metro cluster;
after receiving the write request, receiving an abort task from the host for aborting the write request; and
in response to receipt of the abort task, delaying, by the first array, a successful response to the abort task back to the host until after the first array receives a notification that the second array has acquired a lock on the specified range in the second array.

2. The method of claim 1, further comprising, prior to receiving the abort task, acquiring a first lock on the specified range by the first array.

3. The method of claim 2, further comprising the first array releasing the first lock on the specified range on the first array after the second array releases the lock on the specified range on the second array.

4. The method of claim 2, further comprising completing the write request in the first array and completing the write request in the second array, such that the specified range reflects the specified data of the write request in both the first array and the second array.

5. The method of claim 2, further comprising the second array selectively determining contents of the specified range after the write request is aborted to be one of (i) original data prior to receiving the write request or (ii) new data specified by the write request, wherein the method further comprises the second array releasing the lock after making the determination.

6. The method of claim 5, further comprising the second array receiving a message from the first array indicating that the write request is being aborted, wherein selectively determining the contents of the specified range is based on whether the second array has begun writing the specified data to the specified range in the second array when the second array receives the message from the first array.

7. The method of claim 5, further comprising the second array receiving a message from the first array indicating that the write request is being aborted, wherein selectively determining the contents of the specified range includes the second array determining the contents to be the original data prior to receiving the write request, based on the second array not having begun writing the specified data to the specified range in the second array when the second array receives the message from the first array.

8. The method of claim 7, further comprising maintaining the contents of the specified range in the first array to be the original data prior to receiving the write request.

9. The method of claim 5, further comprising the second array receiving a message from the first array indicating that the write request is being aborted, wherein selectively determining the contents of the specified range includes the second array determining the contents to be the new data specified by the write request, based on the second array having already begun writing the specified data to the specified range in the second array when the second array receives the message from the first array, and wherein the method further comprises setting the contents of the specified range in the first array to be the new data specified by the write request.

10. A computerized apparatus, comprising a first array of a metro cluster that includes the first array and a second array, the first array including control circuitry that includes a set of processors coupled to memory, the control circuitry constructed and arranged to:
receive a write request from a host, the write request specifying data to be written to a specified range of a stretched volume of the metro cluster;
after receipt of the write request, receive an abort task from the host for aborting the write request; and
in response to receipt of the abort task, delay a successful response to the abort task back to the host until after receipt of a notification that the second array has acquired a lock on the specified range in the second array.

11. A computer program product including a set of non-transitory, computer-readable media having instructions which, when executed by control circuitry of at least one computerized apparatus, cause the control circuitry to perform a method of managing abort tasks in a metro cluster that includes a first array and a second array, the method comprising:
receiving, by the first array, a write request from a host, the write request specifying data to be written to a specified range of a stretched volume of the metro cluster;
after receiving the write request, receiving an abort task from the host for aborting the write request; and
in response to receipt of the abort task, delaying, by the first array, a successful response to the abort task back to the host until after the first array receives a notification that the second array has acquired a lock on the specified range in the second array.

12. The computer program product of claim 11, further comprising, prior to receiving the abort task, acquiring a first lock on the specified range by the first array.

13. The computer program product of claim 12, further comprising the first array releasing the first lock on the specified range on the first array after the second array releases the lock on the specified range on the second array.

14. The computer program product of claim 12, further comprising completing the write request in the first array and completing the write request in the second array, such that the specified range reflects the specified data of the write request in both the first array and the second array.

15. The computer program product of claim 12, further comprising the second array selectively determining contents of the specified range after the write request is aborted to be one of (i) original data prior to receiving the write request or (ii) new data specified by the write request, wherein the method further comprises the second array releasing the lock after making the determination.

16. The computer program product of claim 15, further comprising the second array receiving a message from the first array indicating that the write request is being aborted, wherein selectively determining the contents of the specified range is based on whether the second array has begun writing the specified data to the specified range in the second array when the second array receives the message from the first array.

17. The computer program product of claim 15, further comprising the second array receiving a message from the first array indicating that the write request is being aborted, wherein selectively determining the contents of the specified range includes the second array determining the contents to be the original data prior to receiving the write request, based on the second array not having begun writing the specified data to the specified range in the second array when the second array receives the message from the first array.

18. The computer program product of claim 17, further comprising maintaining the contents of the specified range in the first array to be the original data prior to receiving the write request.

19. The computer program product of claim 15, further comprising the second array receiving a message from the first array indicating that the write request is being aborted, wherein selectively determining the contents of the specified range includes the second array determining the contents to be the new data specified by the write request, based on the second array having already begun writing the specified data to the specified range in the second array when the second array receives the message from the first array.

20. The computer program product of claim 19, wherein the method further comprises setting the contents of the specified range in the first array to be the new data specified by the write request.
